(19) United States
(12) Patent Application Publication
(10) Pub. No.: US 2017/0017576 A1
(43) Pub. Date: Jan. 19, 2017

(54) Self-adaptive Cache Architecture Based on Run-time Hardware Counters and Offline Profiling of Applications

(71) Applicant: QUALCOMM Incorporated, San Diego, CA (US)

(72) Inventors: Rosario Cammarota, San Diego, CA (US); Kishore Yalamanchili, San Diego, CA (US); Amin Ansari, San Diego, CA (US); Amrit Kumar Panda, San Diego, CA (US); Rodolfo Giacomo Beraha, San Diego, CA (US)

(21) Appl. No.: 14/801,329

(22) Filed: Jul. 16, 2015

(51) Int. Cl. G06F 12/08; G06N 5/04; G06N 99/00

(52) U.S. Cl. CPC G06F 12/0893; G06N 99/005; G06N 5/04; G06F 2212/1008; G06F 2212/604

(57) ABSTRACT

Aspects include computing devices, systems, and methods for implementing generating a cache memory configuration. A server may apply machine learning to context data. The server may determine a cache memory configuration relating to the context data for a cache memory of a computing device and predict execution of an application on the computing device. Aspects include computing devices, systems, and methods for implementing configuring a cache memory of the computing device. The computing device may classify a plurality of cache memory configurations, related to a predicted application execution, based on at least a hardware data threshold and a first hardware data. The computing device may select a first cache memory configuration from the plurality of cache memory configurations in response to the first cache memory configuration being classified for the first hardware data, and configuring the cache memory at runtime based on the first cache memory configuration.

### BACKGROUND

Current general purpose processor designs (e.g., a main application processor) devote a large, sometimes the largest, fractions of on-chip transistors to cache memory for temporarily storing processor information for quick access. Static general purpose processor on-chip transistor configurations for cache memory lead to largely underutilized cache memory resources, and burn a significant fraction of a system power budget to manage the cache resources even when not in use or when used inefficiently. These static cache memory configurations also result inconsistent performance for different applications because of their rigid cache management policies. One cache memory configuration implementation does not provide consistent or desirable performance for all applications under varying circumstances. This is because, in part, different applications exhibit different cache memory access patterns and the cache memory configuration may not be efficiently or desirably setup for the different cache memory access patterns. Inefficient or undesired use of the cache results in unfavorable performance, power consumption, and thermal generation.

### SUMMARY

The methods and apparatuses of various aspects provide circuits and methods for generating a cache memory configuration including applying machine learning to context data, determining a first cache memory configuration relating to the context data for a cache memory of a computing device, and predicting execution of an application on the computing device.

The methods and apparatuses of various aspects provide circuits and methods for implementing configuring a cache memory of a computing device including classifying a plurality of cache memory configurations based on at least a hardware data threshold of the computing device and first hardware data of the computing device in which the plurality of cache memory configurations are related to a predicted application execution, selecting a first cache memory configuration from the plurality of cache memory configurations in response to the classification of the plurality of cache memory configurations indicating the first cache memory configuration as classified for the first hardware data of the computing device, and configuring the cache memory at runtime based on the first cache memory configuration.

In an aspect, applying machine learning to context data may include applying machine learning to the context data and hardware data of the computing device related to the context data, and determining a first cache memory configuration relating to the context data for a cache memory of a computing device may include determining the first cache memory configuration relating to the context data and hardware data thresholds for the cache memory of the computing device.

An aspect method may further include correlating the predicted application and the first cache memory configuration.

An aspect method may further include validating the predicted application and the first cache memory configuration, storing the predicted application and the first cache memory configuration in response to the predicted application and the first cache memory configuration being valid, and altering the machine learning with an error value in response to the predicted application and the first cache memory configuration being invalid.

An aspect method may further include classifying a plurality of cache memory configurations based on at least a hardware data threshold of the computing device and first hardware data of the computing device in which the plurality of cache memory configurations are related to a predicted application execution, selecting the first cache memory configuration from the plurality of cache memory configurations in response to the classification of the plurality of cache memory configurations indicating the first cache memory configuration as classified for the first hardware data of the computing device, and configuring the cache memory at runtime based on the first cache memory configuration.

An aspect method may further include receiving a plurality of cache memory parameters, in which each of the plurality of cache memory parameters are associated with context data, at least one hardware data threshold of the computing device, the predicted application execution, and at least one cache memory configuration.

An aspect method may further include receiving second hardware data of the computing device after configuring the cache memory at runtime based on the selected first cache memory configuration, classifying the plurality of cache memory configurations based on at least one hardware data threshold of the computing device and the second hardware data of the computing device, selecting a second cache memory configuration from the plurality of cache memory configurations in response to the classification of the plurality of cache memory configurations indicating the second cache memory configuration as classified for the second hardware data of the computing device, and configuring the cache memory at runtime based on the second cache memory configuration.

In an aspect, the first hardware data and the second hardware data each may include at least one of cache memory related data, data related to a first processor in which the first processor is associated with a dedicated cache memory, data related to a second processor, and data related to a third processor in which the second processor and the third processor are associated with a shared cache memory.

An aspect includes a computing device having a cache memory, and a processor coupled to the cache memory and configured with processor-executable instructions to perform operations of one or more aspect methods described above. An aspect includes a computing device having means for performing functions of one or more of the aspect methods described above. An aspect includes a non-transitory processor-readable medium having stored thereon processor-executable software instructions to cause a processor to perform operations of one or more of the aspect methods described above.

### BRIEF DESCRIPTION OF THE DRAWINGS

The accompanying drawings, which are incorporated herein and constitute part of this specification, illustrate example aspects of the claims, and together with the general description given above and the detailed description given below, serve to explain the features of the claims.

FIG. 1 is a component block diagram illustrating an example computing device suitable for implementing an aspect.

FIG. 2 is a component block diagram illustrating an example multi-core processor suitable for implementing an aspect.

FIG. 3 is a component block diagram illustrating an example system on chip (SoC) suitable for implementing an aspect.

FIG. 4 is a component block diagram illustrating an example computing device having a system cache shared by multiple processors, subsystems, and/or components in accordance with an aspect.

FIG. 5 is a component block and process flow diagram illustrating an example self-adaptive cache memory configuration system in accordance with an aspect.

FIG. 6 is a schematic and process flow diagram illustrating an example of application prediction in accordance with an aspect.

FIG. 7 is a schematic and process flow diagram illustrating an example of cache memory configuration parameter threshold generation in accordance with an aspect.

FIG. 8 is a schematic diagram illustrating an example relational storage of cache memory configuration parameters in accordance with an aspect.

FIG. 9 is a schematic diagram illustrating an example cache memory variably configured in accordance with an aspect.

FIG. 10 is a process flow diagram illustrating an aspect method for cache memory configuration parameter generation.

FIG. 11 is a process flow diagram illustrating an aspect method for self-adaptive cache memory configuration.

FIG. 12 is component block diagram illustrating an example mobile device suitable for use with the various aspects.

FIG. 13 is component block diagram illustrating an example mobile device suitable for use with the various aspects.

FIG. 14 is component block diagram illustrating an example server device suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices that include a memory, and a programmable processor. The term “computing device” may also refer to stationary devices, such as desktop computers and servers, including individual server blades and server systems. While the various aspects are particularly useful for mobile computing devices, such as smartphones, which have limited energy resources, the aspects are generally useful in any electronic device that implements a plurality of memory devices and a limited energy budget where reducing the power consumption of the memory devices can extend the battery-operating time of the mobile computing device. The various aspects are also useful in any electronic device having a continuous power supply from a power source, such as an electrical utility grid or a power generator, such as a fuel cell or other alternative or renewable energy source, where performance of the electronic device may be increased while potentially increasing power consumption.

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The methods, systems, and devices described herein improve computing device performance by implementing a configurable cache memory, and by matching the cache memory structure and management to applications' needs. Configuring a cache memory structure and management, is accomplished though using computing device cache usage predictions developed by models from context information for improving performance, energy efficiency, and/or thermal generation when executing different applications.

Context information used in making computing device cache usage predictions may be provided from multiple sources. The context information may include data related to an application executed by the computing device. The application and application data may be analyzed offline to provide a profile of the application and its usage. The application may be analyzed offline using multiple techniques, including static, dynamic, or a hybrid of static and dynamic analysis of the application's code and its execution on the computing device.

Computing device application execution information used in making computing device cache usage predictions may include the usage information during the execution of the application, as well as the application's needs, such as data locality and which features of the computing device execution the application uses. The context information may be gathered from a specific computing device and/or from a population of similar computing devices.

Other context information used in making computing device cache usage predictions may include usage and state information from the computing device. The computing device usage and state information may include a variety of parameters including general historic usage information (e.g., types of usage at various locations and times), hardware counter information that indicates the frequency with which various hardware elements are used or accessed, cache memory configuration and usage data (e.g., working set size and number of reads, writes, and misses), and computing device state information (e.g., processing frequency, temperature, current leakage, and power availability).

An offline model, which may include a variety and/or combination of learning models and first classification models, uses and correlates the context information to develop user behavior predictions, such as identifying a likely next application for execution, group of applications for execution, or manner of using the computing device. Learning models analyze the context information to determine different sets of context information that correlate with the different user behaviors. First classification models analyze the correlated sets of context information and user behaviors to determine the likelihood of specific user behaviors or application executions for various parameters included in the context information. The resulting user behavior and application predictions may be subjected to model validation to test whether the user behavior and application predictions are accurate. The model validation may result in rejection of the user behavior predictions, in response to which the learning model and first classification model may use data from the model validation to update the user behavior and application predictions. The model validation may result in approval of the user behavior and application predictions, in response to which user behavior and application predictions may be made available for use by the computing device. For example, a database relating user behavior and application predictions with context information may be accessible by the computing device, and user behavior and application predictions may be provided to the computing device based on parameters aligned with the associated context information.

A second classification model may be implemented to determine cache memory configuration threshold classifications for the user behavior and application predictions at run-time. The second classification model may analyze the user behavior and application predictions, along with historical and current usage information, to determine whether it is appropriate to implement cache memory configurations for the user behavior and application predictions, modify cache memory configurations for the user behavior and application predictions, or ignore the user behavior and application predictions. The second classification model may be provided with multiple user behavior and application predictions and may determine one or more cache memory configuration threshold classifications for implementing cache memory configuration. The second classification model may generate cache memory configuration threshold classifications for configuring various cache memory parameters (e.g., cache memory activation/deactivation, reservation for a particular use, size, level usage settings, associativity, line size, and management policy). The second classification model may determine the various threshold classifications for optimizing the cache memory configuration based on the computing device historical and current usage information. The threshold classifications may be associated with certain operating parameters of the computing device such that the threshold classifications provide cache memory configuration parameters tailored to the operating parameters. The second classification model may determine the cache memory configuration parameters to use for configuring the cache memory based on an analysis of the computing device usage information compared with the cache memory configuration threshold classifications. The computing device usage information, such as the operating parameters of the computing device, may be compared to the threshold classifications, and the threshold classification best suited for the computing device usage information may be selected for implementing the associated cache memory configuration.

The cache memory configuration parameters, which may take the form of a cache memory configuration vector, associated with the determined cache memory configuration threshold classifications may be used by a cache memory configuration engine for configuring an entire cache memory or portions/partitions of a cache memory. The cache memory configuration engine may receive the cache memory configuration parameters to use for configuring the cache memory based on the analysis of the computing device usage information compared with the cache memory configuration threshold classifications. The cache memory configuration engine may modify the configuration of a cache memory by modifying the cache configuration memory parameters (e.g., cache memory activation/deactivation, reservation for a particular use, size, level usage settings, associativity, line size, and management policy) of the cache memory as provided from the second classification model.

The methods, systems, and devices for implementing the configurable cache memory may be implemented on multiple platforms with different elements executed on different computing devices depending on the processing capabilities and power constraints of the computing device having the configurable cache memory. Such computing devices may include servers, mobile devices, and other computing devices with processing capabilities and at least intermittent connections to a network (e.g., the Internet, such that these devices are part of the Internet of Things). In an example, a server may include sufficient processing and power resources to implement the models, model validation, model classification, and cache memory configuration. In another example, a mobile device may have processing and power budgets that make implementing the learning and first classification models and model validation on a server more efficient, and the mobile device may implement the model classification and cache memory configuration. In a further example, the processing and power budgets of an Internet of Things computing device may be such that it is more efficient to implement the learning and first classification models, model validation, and model classification on a server, and the Internet of Things computing device may implement the cache memory configuration. In another example, multiple computing devices may implement cache memory configuration models for implementing an application, such as a cloud server may configure its cache memory for providing a cloud implemented service, and a mobile device may configure its cache memory to interact with the cloud server.

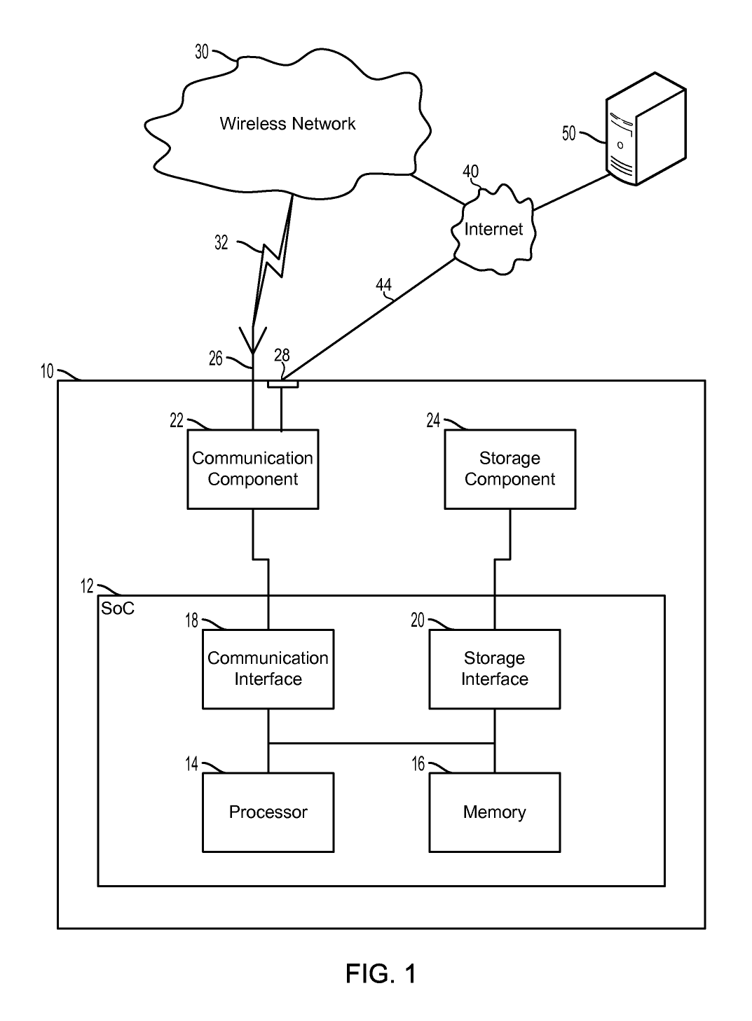

The methods, systems, and devices of the various aspects may be implemented on a variety of different computing device or system architectures. Therefore, references to particular types of processor configurations or system architectures are for example purposes only, and are not intended to limit the scope of the claims. In particular, three different system architectures on which the various aspects may be implemented are illustrated in FIGS. 1-3 and described below for purposes of providing example hardware and system architectures for implementing the various aspects.

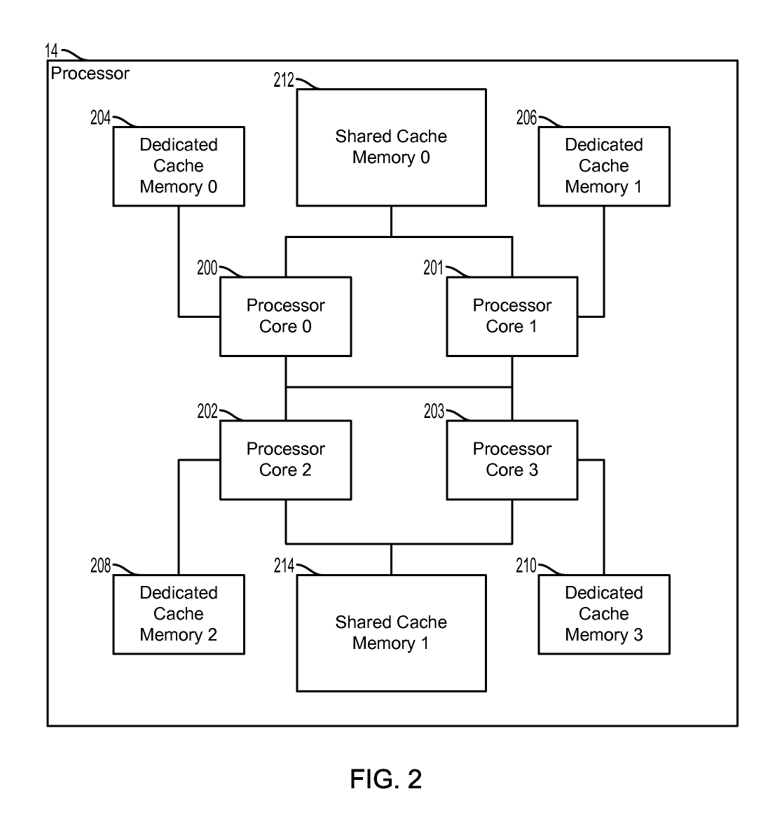

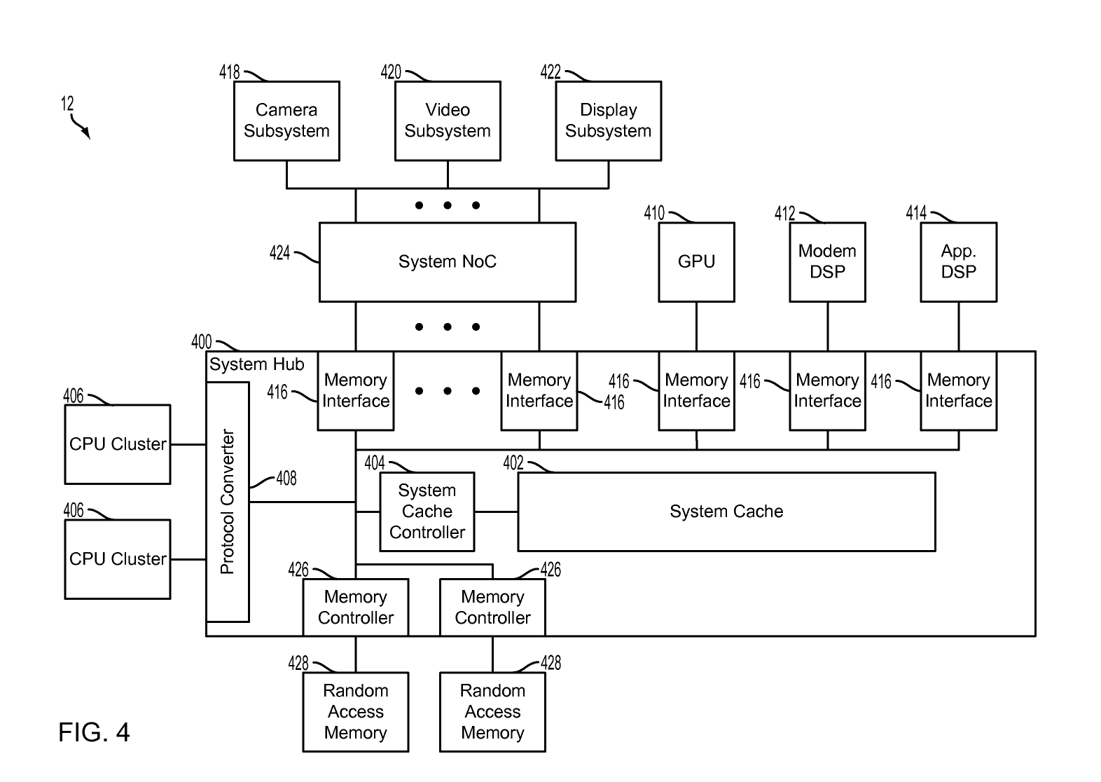

FIG. 1 illustrates a system including a computing device 10 in communication with a remote computing device 50 suitable for use with the various aspects. The computing device 10 may include an SoC 12 with a processor 14, a memory 16, a communication interface 18, and a storage interface 20. The computing device may further include a communication component 22 such as a wired or wireless modem, a storage component 24, an antenna 26 for establishing a wireless connection 32 to a wireless network 30, and/or the network interface 28 or connecting to a wired connection 44 to the Internet 40. The processor 14 may include any of a variety of hardware cores, as well as a number of processor cores. The SoC 12 may include one or more processors 14. The computing device 10 may include more than SoCs 12, thereby increasing the number of processors 14 and processor cores. The computing device 10 may also include processor cores 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together as part of one or more subsystems of the computing device 10 as described below with reference to FIG. 4.

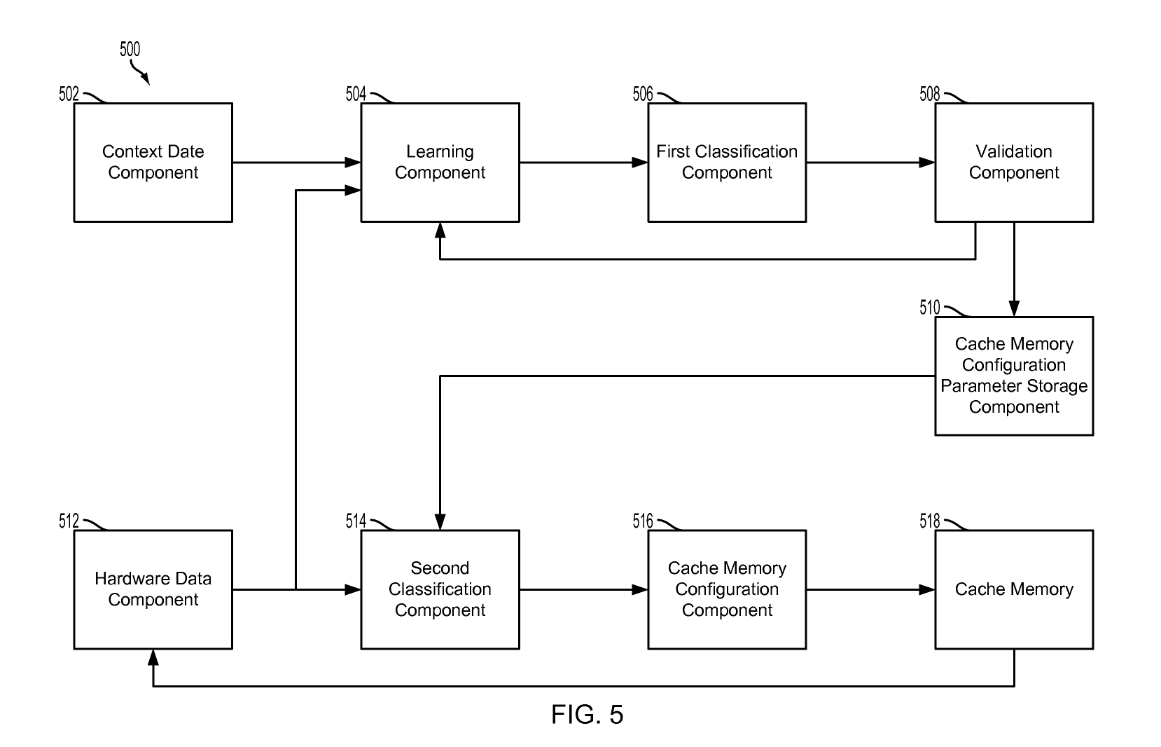

The memory 16 of the SoC 12 may be a volatile or non-volatile memory configured for storing data and processor-executable code for access by the processor 14. In an aspect, one or more memories 16 may include volatile memories such as random access memory (RAM) or main memory, cache memory, or hardware registers. These memories 16 may be configured to temporarily hold a limited amount of data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory. In an aspect, the memory 16 may be configured to store data for implementing for cache memory configuration parameter generation and self-adaptive cache memory configuration operations (described further with reference to FIGS. 5-7, 10, and 11). In an aspect, the memory 16 may be configured to store hardware data and context data for delayed access for the cache memory configuration parameter generation and the self-adaptive cache memory configuration operations. As discussed in further detail below, each of the processor cores may access a variety of cache memory partitions.

The computing device 10 and/or SoC 12 may include one or more memories 16 configured for various purposes. In an aspect, one or more memories 16 may be configured to be dedicated to storing the cache memory configuration parameters that dictate the behavior and accessibility of a configured cache memory. In an aspect, one or more memories 16 may be configured to be dedicated to storing the hardware data and the context data for delayed access for the cache memory configuration parameter generation and the self-adaptive cache memory configuration operations. When the memory 16 storing the cache memory configuration parameters and/or the hardware data and the context data is non-volatile, the memory 16 may retain the cache memory configuration parameters and/or the hardware data and the context data even after the power of the computing device 10 has been shut off. When the power is turned back on and the computing device 10 reboots, the cache memory configuration parameters and/or the hardware data and the context data stored in non-volatile memory 16 may be available to the computing device 10.

The communication interface 18, communication component 22, antenna 26 and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50. In an aspect, the computing device 10 may transmit the hardware data and the context data to the computing device 50. In an aspect, the computing device 50 may transmit cache memory configuration parameters to the computing device 10.

The storage interface 20 and the storage component 24 may work in unison to allow the computing device 10 to store data on a non-volatile storage medium. The storage component 24 may be configured much like an aspect of the memory 16 in which the storage component 24 may store the cache memory configuration parameters and/or the hardware data and the context data, such that the parameters and data may be accessed by one or more processors 14. The storage component 24, being non-volatile, may retain the cache memory configuration parameters and/or the hardware data and the context data even after the power of the computing device 10 has been shut off. When the power is turned back on and the computing device 10 reboots, the cache memory configuration parameters and/or the hardware data and the context data stored on the storage component 24 may be available to the computing device 10. The storage interface 20 may control access to the storage device 24 and allow the processor 14 to read data from and write data to the storage device 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an aspect. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. The heterogeneity of such heterogeneous processor cores may include different instruction set architecture, pipelines, operating frequencies, etc.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various aspects to a four-core processor system. The computing device 10, the SoC 12, or the multi-core processor 14 may individually or in combination include fewer or more than the four processor cores 200, 201, 202, 203 illustrated and described herein.

In an aspect, the processor cores 200, 201, 202, 203 may have associated dedicated cache memories 204, 206, 208, 210. Like the memory 16 in FIG. 1, dedicated cache memories 204, 206, 208, 210 may be configured to temporarily hold a limited amount of data and/or processor-executable code instructions that is requested from non-volatile memory or loaded from non-volatile memory in anticipation of future access. The dedicated cache memories 204, 206, 208, 210 may also be configured to store intermediary processing data and/or processor-executable code instructions produced by the processor cores 200, 201, 202, 203 and temporarily stored for future quick access without being stored in non-volatile memory. The dedicated cache memories 204, 206, 208, 210 may each be associated with one of the processor cores 200, 201, 202, 203. Each dedicated cache memory 204, 206, 208, 210 may be accessed by its respective associated processor core 200, 201, 202, 203. In the example illustrated in FIG. 2, each processor core 200, 201, 202, 203 is in communication with one of the dedicated cache memories 204, 206, 208, 210 (e.g., processor core 0 is paired with dedicated cache memory 0, processor core 1 with dedicated cache memory 1, processor core 2 with dedicated cache memory 2, and processor core 3 with dedicated cache memory 3). Each processor core 200, 201, 202, 203 is shown to be in communication with only one dedicated cache memory 204, 206, 208, 210, however the number of dedicated cache memories is not meant to be limiting and may vary for each processor core 200, 201, 202, 203.

In an aspect, the processor cores 200, 201, 202, 203 may have associated shared cache memories 212, 214. The shared cache memories 212, 214 may be configured to perform similar functions to the dedicated cache memory 204, 206, 208, 210. However, the shared cache memories 212, 214 may each be in communication with more than one of the processor cores 200, 201, 202, 203 (e.g., processor core 0 and processor core 1 are paired with shared cache memory 0, and processor core 2 and processor core 3 are paired with shared cache memory 1). Each processor core 200, 201, 202, 203 is shown to be in communication with only one shared cache memory 212, 214, however the number of shared cache memories is not meant to be limiting and may vary for each processor core 200, 201, 202, 203. Similarly, each shared cache memory is shown to be in communication with only two processor cores 200, 201, 202, 203, however the number of processor cores is not meant to be limiting and may vary for each shared cache memory 212, 214. The processor cores 200, 201, 202, 203 in communication with the same shared cache memory 212, 214, may be grouped together in a processor cluster as described further herein.

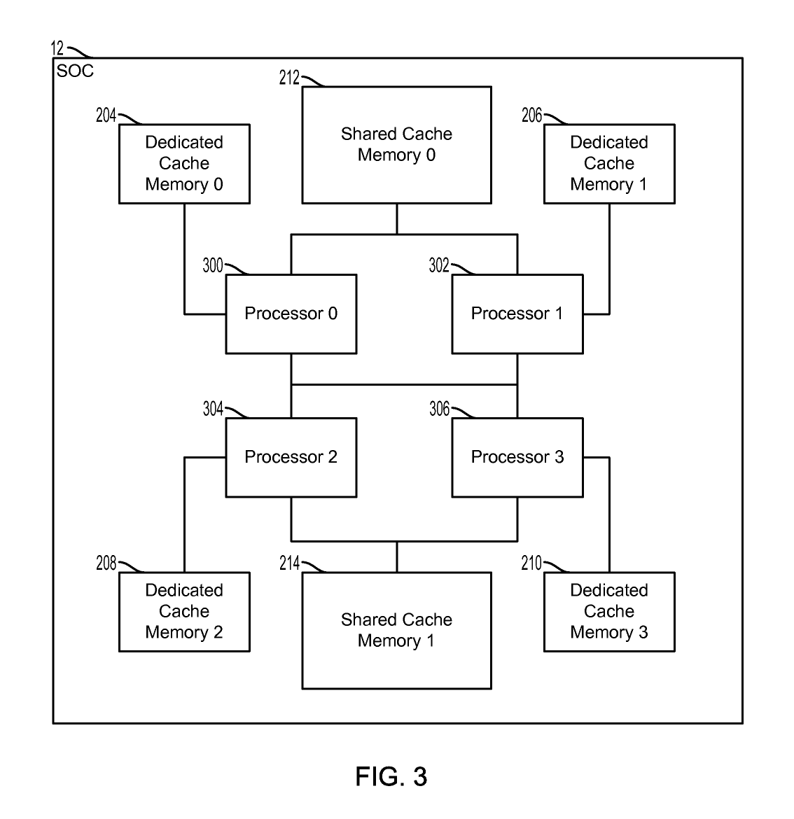

FIG. 3 illustrates an SoC 12 suitable for implementing an aspect. The SoC 12 may have a plurality of homogeneous or heterogeneous processors 300, 302, 304, 306. Each of the processors 300, 302, 304, 306 may be similar to the processor 14 in FIG. 2. The purposes and/or performance characteristics of each processor 300, 302, 304, 306 may determine whether the processors 300, 302, 304, 306 are homogeneous or heterogeneous in a similar manner as the processor cores 200, 201, 202, 203 in FIG. 2.

The dedicated cache memories 204, 206, 208, 210 and shared cache memories 212, 214 are also similar to the same components described in FIG. 2, however here the dedicated cache memories 204, 206, 208, 210 and shared cache memories 212, 214 are in communication with the processors 300, 302, 304, 306. The number and configuration of the components of the SoC 12 is not meant to be limiting, and the SoC 12 may include more or fewer of any of the components in varying arrangements.

In an aspect, the processors and processor cores described herein need not be located on the same SoC or processor to share a shared cache memory. The processors and processor cores may be distributed across various components while maintaining a connection to the same shared cache memory as one or more other processors or processor cores.

FIG. 4 illustrates a computing device with a system cache memory suitable for implementing an aspect. With reference to FIGS. 1-3, the SoC 12 may include a variety of components as described above. Some such components and additional components may be employed to implement the cache memory configuration parameter generation and the self-adaptive cache memory configuration operations (described further with reference to FIGS. 5-7, 10, and 11). For example, an SoC 12 configured to implement the cache memory configuration parameter generation and the self-adaptive cache memory configuration operations may include a system hub 400, a system cache 402, a system cache controller 404, a CPU cluster 406, a protocol converter 408, a GPU 410, a modem DSP 412, an application DSP 414, a memory interface 416, a camera subsystem 418, a video subsystem 420, a display subsystem 422, a system network on chip (NoC) 424, a memory controller 426, and a random access memory (RAM) 428. The system hub 400 may be a component of the SoC 12 that manages access to and maintenance of the various memories by the various processors 406, 410, 412, 414. In an aspect the system hub 400 may manage accesses to and maintenance of the system cache 402 of the SoC 12 and also accesses to the RAM 428. Some of the processors that may access the various memories may be included in the CPU clusters 406 and the various subsystems, such as the camera, video, and display subsystems 418, 420, 422, and may also include other specialized processors such as the GPU 410, the modem DSP 412, and the application DSP 414.

The system cache 402 may be a shared memory device in the SoC 12 used to replace or supplement cache memories that may be associated with the various processors and/or subsystems. The system cache 402 may centralize the cache memory resources of the SoC 12 so that the various processors and subsystems may access the system cache 402 to read and write program commands and data designated for repeated and/or quick access. The system cache 402 may store data from the various processors and subsystems, and also from other memory devices of the computing device, such as main memory, the RAM 428, and the storage device (e.g., a hard disk drive). In an aspect, the system cache 402 may be backed up by such memory and storage devices in case a cache miss occurs because an item requested from the system cache 402 cannot be located. In an aspect, the system cache 402 may be used as scratchpad memory for the various processors and subsystems. The system cache 402 may be smaller in storage space and physical size than a combination of the local cache memories of an SoC of similar architecture that does not employ a system cache 402. However, management of the system cache 402 as described further herein may allow for greater energy conservation and equal or better performance speed of the SoC 12 despite of the system cache's smaller storage space and physical size, and may allow for use of a simple software call flow.

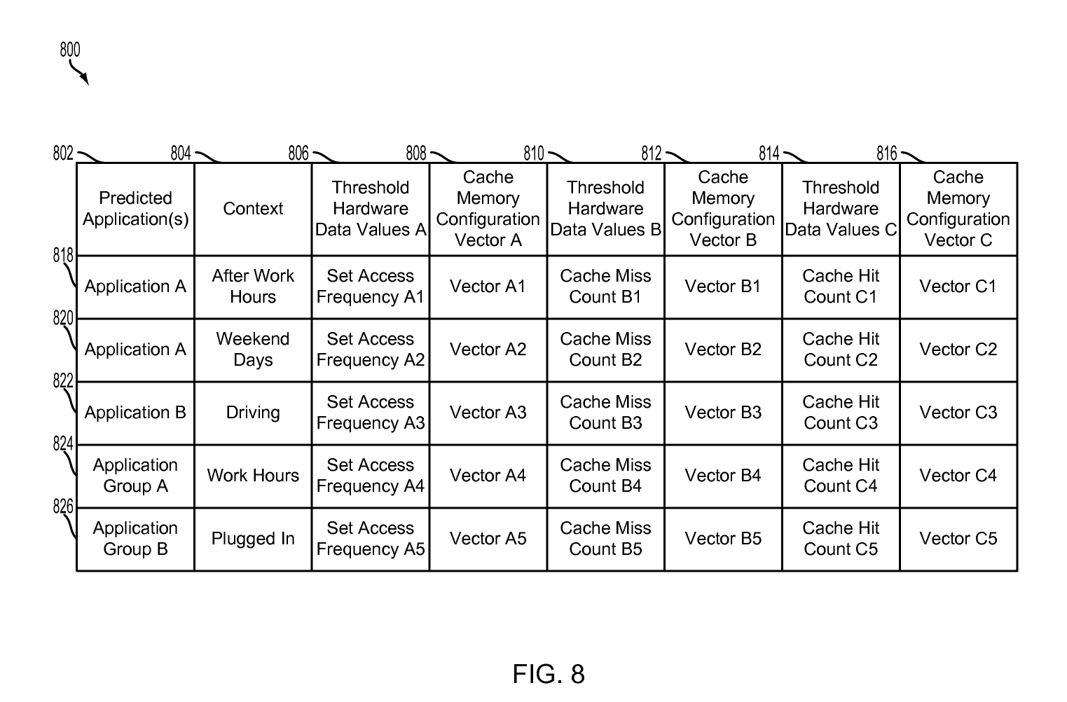

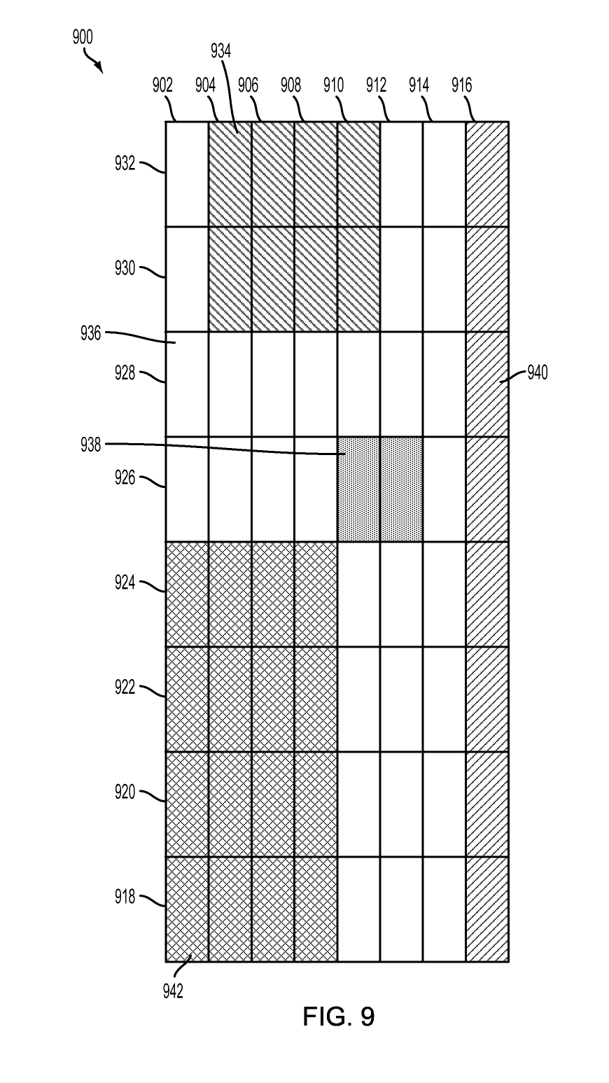

The system cache controller 404 may manage access to and maintenance of the system cache 402 by the various processors and subsystems. Part of the access management of the system cache 402 may include managing the partitions the system cache memory space. The system cache memory space may be partitioned in a variety of manners, including, but not limited to, by cache words, cache lines, cache pages, cache ways, cache sets, cache banks, a partition indication field in a cache tag, or a combination of these parameters. Partitioning the system cache memory space may result in cache memory partitions of various sizes and locations in the system cache memory space. The size, location, and other aspects of the cache memory partitions may be dictated by the cache memory configuration parameters (discussed further with reference to FIGS. 8 and 9). The system cache controller 404 may include hardware, such as a number of registers, configured to maintain records of these cache memory partitions and relate various traits/features/parameters to each of the cache memory partitions.

The CPU clusters 406 may include groupings of several general purpose processors and/or general purpose processor cores. The CPU clusters 406 may access and maintain the system cache 402 via the system cache controller 404. Communications between the CPU clusters 406 and the system cache controller 404 may be converted by a protocol converter 408 from a standard or proprietary protocol of one of the CPU clusters 406 and the system cache controller 404 to a protocol suitable for the other in order to achieve interoperability between them. The CPU clusters 406 may send system cache access requests and cache maintenance and status commands specifying a particular cache memory partition to the system cache controller 404. In return, the system cache controller 404 may allow or deny access to the specified cache memory partition, return the information stored in the specified cache memory partition to the CPU clusters 406, and implement the cache maintenance and status commands.

Similar to the CPU clusters 406, specialized processors, like the GPU 410, the modem DSP 412, and the application DSP 414, may access and maintain the system cache 402 via the system cache controller 404. Communications between the specialized processors 410, 412, 414, and the system cache controller 404 may be managed by dedicated, individual memory interfaces 416. In an aspect memory interfaces 416 may manage communications between multiple similar or disparate specialized processors 410, 412, 414, and the system cache controller 404.

Various subsystems, like the camera subsystem 418, the video subsystem 420, and the display subsystem 422, may similarly access and maintain the system cache 402 via the system cache controller 404 and memory interfaces 416. The NoC 424 may manage the communication traffic between the subsystems 418, 420, 422, and the system hub 400 as well as other components of the SoC 12.

The system cache controller 404 may also manage accesses to the RAM 428 by the various processors and subsystems of the SoC 12. While the various processors and subsystems may make direct access requests to the RAM 428 via the memory controller 426, in certain instances system cache access requests may be directed to the RAM 428. In an aspect, system cache access requests may result in cache misses when the information requested from a specified component cache is not found in the specified component cache. As a result, the system cache controller 404 may direct the system cache access requests to the RAM 428 to retrieve the requested information not found in the component cache. In an aspect, the request for the information directed to the RAM 428 may be directed first to the memory controller 426 that may control access to the RAM 428. The request for the information directed to the RAM 428 may be sent by the system cache controller 404, and the resulting information may be returned to the system cache controller 404 to be written to the cache memory partition and returned from cache memory partition to the components making the system cache access requests. In an aspect, the resulting information may be returned directly, or via the system cache controller 404, to the components making the system cache access requests without being written to the component cache.

In some aspects, portions of the cache memory controller 404 may be implemented and configured in hardware and/or firmware to perform operations of the aspect methods. In some aspects, the cache memory controller 404 may be a programmable controller that is configured by controller-executable instructions to perform operations of the aspect methods. In some aspects, the cache memory controller 404 may be implemented and configured through a combination of firmware and controller-executable instructions to perform operations of the aspect methods.

The descriptions herein of SoC 12 and its various components are only meant to be exemplary and in no way limiting. Several of the components of the SoC 12 may be variably configured, combined, and separated. Several of the components may be included in greater or fewer numbers, and may be located and connected differently within the SoC 12 or separate from the SoC 12. Similarly, numerous other components, such as other memories, processors, subsystems, interfaces, and controllers, may be included in the SoC 12 and in communication with the system cache controller 404 in order to access the system cache 402.

FIG. 5 illustrates a self-adaptive cache memory configuration system in accordance with an aspect. With reference to FIGS. 1-4, the self-adaptive cache memory configuration system 500 may include a context data component 502, a learning component 504, a first classification component 506, a validation component 508, a cache memory configuration parameters storage component 510, a hardware data component 512, a second classification component 514, a cache memory configuration component 516, and a cache memory 518. Varying components 502-516 of the self-adaptive cache memory configuration system 500 may implement their respective functions offline or during runtime of the computing device 10 implementing self-adaptive cache memory configuration for the cache memory 518. The components 502-516 implementing their respective functions on the remote computing device 50 are executing offline. The components 502-516 implementing their respective functions on the computing device 10 may be executing offline or during runtime. It is possible for offline execution on the remote computing device 50 to coincide with runtime execution on the computing device 10. Each of the components 502-516 may be implemented in hardware, software, firmware, or any combination of the preceding.

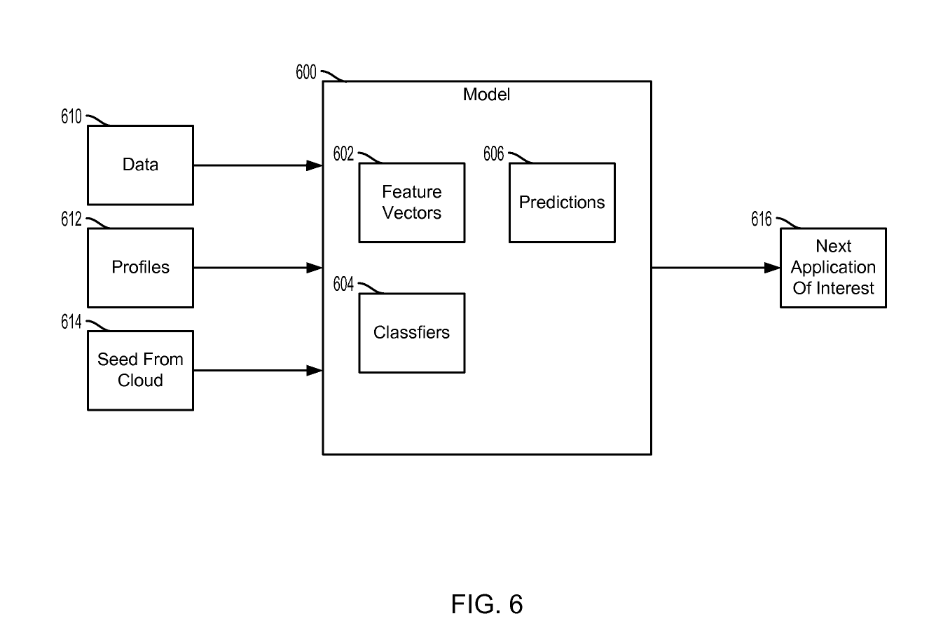

The context data component 502 may be configured to collect context data from various sources, store the context data, and provide the context data to the self-adaptive cache memory configuration system 500 for implementing cache memory configuration parameter generation. Context data may include application and computing device usage user behavior from the computing device 10 and/or other computing device exhibiting similarities with the computing device 10 (e.g., type of computing device, geographic location of the computing device, computing device user characteristics, similar application and computing device usage user behavior, etc.). Context data may also include applications profiles and seed context data for computing devices that do not have at least a requisite amount of application and computing device usage user behavior history. Compositions of context data are discussed further with reference to FIG. 6. In an aspect, the context data component 502 may provide context data relevant for predicting application use and generating cache memory configuration parameters for individual or groups of applications and/or computing devices 10.

The learning component 504 may implement machine learning to determine cache memory configuration vectors associated with various context data. The learning component 504 may receive context data related to certain applications and/or historical computing device usage user behavior from the context data component 502. In an aspect, the context data received from the context data component 502 may be supplemented with specific hardware data related to the context information received from the computing device 10. The data used by the learning component 504 is discussed further with reference to FIG. 6. The learning component 504 may use a variety, including combinations, of machine learning models, both supervised and unsupervised machine learning models to correlate the context data with the hardware data, and to determine cache memory configuration vectors associated with various context data. The learning models may including any know learning model, such a random forests and Naïve Bayes. The learning component 504 may receive data from the context data component 502 and/or the computing device 10, and learning model may find correlations between the data from the various sources. Using the correlated data, the learning component 504 may identify the computing device resources that are often used or needed relating to execution of certain applications and certain computing device usage user behaviors. Having identified how applications and computing device usage user behaviors relate to the resources of the computing device 10, the learning component 504 may generate a cache memory configuration vectors. The learning models may be tuned for different goals, including improving processing efficiency, improving processing power, and/or improving energy use. The cache memory configuration vectors produced by the learning component 504 may be generated using different learning models for meeting such goals. Multiple cache memory configuration vectors may be generated for each application or computing device usage user behavior to address the variety of goals. Different goals may be used for specific platforms or computing devices, and for different contexts. For example, an application run on a server, the goal may be to increase processor performance, but an application run on a mobile device with low battery may have the goal of decreasing power use or increasing performance while decreasing power use. Therefore, the learning component 504 may generate various cache memory configuration vectors for the same application used in different environments and/or in different ways.

The first classification component 506 may implement prediction algorithms to determine the next likely application or group of applications for use by the computing device. In an aspect, the first classification component 506 may determine a likely computing device usage use behavior. The first classification component 506 may use the context information, including historical data, provided from the context data component 502 or the learning component 504. The first classification component 506 may also take into account any available hardware of the computing device 10. The likely next application, group of applications, and/or computing device usage use data may be correlated with a cache memory configuration vector.

The validation component 508 may implement validation algorithms to check the accuracy of the results from the learning component 504 and the first classification component 506. The validation component 508 may determine whether the predictions of the first classification component 506 are accurate within certain margins of error, which may vary depending on the platform of the computing device 10, depending on the importance of meeting the goals used for implementing the learning component 504. For example, for a consumer computing device the margin of error may be relatively high to the margin of error allowed in a professional or enterprise environment. Validated predictions and cache memory configuration vectors may be provided to the cache memory configuration parameter storage device 510. Not valid predictions and cache memory configuration vectors may result in providing the learning component 504 and the first classification component 506 with data relevant to why the invalid decision. The learning component 504 and the first classification component 506 may incorporate the validation data into the algorithms of the learning component 504 and the first classification component 506 in order to improve the accuracy of the cache memory configuration vectors or the predicted applications, group of applications, or computing device usage use behavior.

The cache memory configuration parameter storage device 510 may store cache memory configuration models for configuring the cache memory 518 of the computing device 10. Each cache memory configuration model may include relevant context information, memory configuration vectors, and the predicted applications, group of applications, and/or computing device usage use behaviors. This information stored on the cache memory configuration parameter storage device 510 may be stored in a manner in which the information for a cache memory configuration model are relationally linked with their relevant information. The storage of cache memory configuration model information is discussed further with reference to FIG. 8. The cache memory configuration parameter storage device 510 may make the cache memory configuration model information available to the computing device 10 for use in self-adaptive cache memory configuration.

The hardware data component 512 may include various types of memory, including volatile and non-volatile memory, for keeping track of aspects of the performance of the computing device running particular applications, groups of applications, or during particular computing device usage use behavior. For example, the hardware data component 512 may keep track of data indicating the number and types of accesses to different portions of the cache memory of the computing device 10. Other hardware data tracked by the hardware data component 512 may include cache misses, cache hits, set access frequency, and stack distance/dead set count for various dedicated or shared memory components and processors/processor cores. The hardware data component 512 may use hardware counters of the computing device 10 to track the hardware data. The hardware data component 512 may make the hardware data available to the learning component 504, the first classification component 506, and the second classification component 514.

The second classification component 514 may receive numerous cache memory configuration models from the cache memory configuration parameter storage device 510. The second classification component 514 may be used to select the cache memory configuration model and the cache memory configuration vector for configuring the cache memory for a predicted application or group of applications, and a predicted computing device usage use behavior. The memory configuration models for consideration may be based on the predictions and the hardware data. The second classification component 514 may use known classification techniques to select the appropriate cache memory configuration model and vector, including, for example, classification and regression tree analysis, support vector machine analysis, and small neural networks. The second classification component 514 may determine a cache memory configuration vector to provide to the cache configuration engine 516.

The cache configuration engine 516 may receive the cache memory configuration vector selected by the second classification component 514, and implement the configuration of the cache memory 518.

In various aspects, the self-adaptive cache memory configuration system 500 may include components included in any one or a combination of computing devices 10, 50. Different computing device 10, 50 may have different capabilities and available resources for being able to implement the components of the self-adaptive cache memory configuration system 500. For example, a mobile device may have sufficient processing power and power budget to implement the second classification component 514 and the cache configuration engine 516, and further include the hardware data component 512 and the cache memory 518. In another example, a server may have sufficient processing power and power budget to implement most or all of the components of the self-adaptive cache memory configuration system 500. In a further example, and Internet of Things Device, like a connected household appliance or wearable device, may only have the processing power to implement the cache memory configuration component 516, along with the cache memory 518 and the hardware data component 512. Any of the components not implemented on the computing device 10 that includes the cache memory 518 may be implemented on a remote computing device 50, and provided to the computing device 10.

FIG. 6 illustrates an example of application prediction in accordance with an aspect. With reference to FIGS. 1-5, a learning and/or first classification model 600 may receive context data. The context data may include a variety of data 610, including data from a particular user, a particular computing device, a group of similar users, and/or a group of similar computing devices. The data 610 may include numerous pieces of information relating to applications executed on the mobile device and user behavior on the mobile device. For example, the data 10 may include applications in use, applications used prior to any current applications being used, the computing device hardware data related to the various applications previously or currently used, a time of day, day of the week, and/or location of the computing device while executing certain applications, and computing device state information (e.g., remaining power budget, processing frequency, temperature, current leakage). The learning and/or first classification model 600 may also receive application profiles 612. Such application profiles 612 may be produced offline and provided to the learning and/or first classification model 600. The application profiles may be the result of static, dynamic, or a hybrid of static and dynamic analysis of the application's code and its execution on the computing device, or on a similar computing device.

The learning and/or first classification model 600 may receive the hardware data of the computing device indicating which and how the hardware resources of the computing device are used in various situations. The hardware data may include cache memory usage information, including the portions of the cache memory are accessed, how often they portions of cache memory are accessed, and how often an access of the portions of cache memory fail and succeed, and processor/processor core data (e.g., number of memory access requests, processing frequency, current leakage, temperature, and power draw) for a processor/processor core associated with a dedicated cache memory or multiple processors/processor cores associated with a shared cache memory. The processor/processor core data may be individual to each processor/processor core associated with the shared cache memory or combined based on association with the shared cache memory. Further, the learning and/or first classification model 600 may receive seed information 614, for example, for a computing device that does not have a requisite amount of historical data to be useful in the learning and/or first classification model 600. The seed information 614 may include a conglomeration of historical data from a variety of Other computing devices.

The learning and/or first classification model 600 may input a number of feature vectors 602 that may include selected information from the data 610, the application profiles 612, the hardware data, and the seed information 614. The learning and/or first classification model 600 may apply the feature vectors 602 to classifiers 604, which may implement learning and/or first classification model operations to generate a predicted application(s) or user behavior 606. As discussed above, the learning and/or first classification model operations may include the operations for implementing various learning and/or first classification models. The learning and/or first classification model 600 may output at least the predicted application(s) or user behavior 616, and may further output context information correlated to the predicted application(s) or user behavior 606.

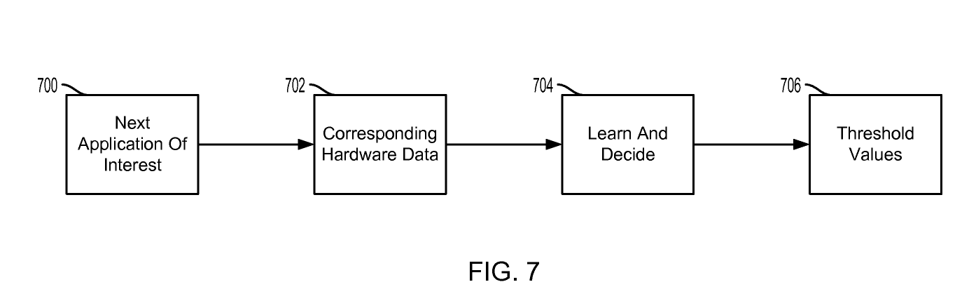

FIG. 7 illustrates an example of cache memory configuration parameter threshold generation in accordance with an aspect. With reference to FIGS. 1-6, the learning and/or first classification model 600 may use a predicted application(s) or user behavior 700, previously output by the learning and/or first classification model 600, as an input. The input may also include context data related to the predicted application(s) or user behavior 700, such as context data relating to how, when, and where the computing device is historically used in relation to the predicted application(s) or user behavior 700. The learning and/or first classification model 600 may also use corresponding hardware data 702 as an input. The corresponding hardware data 703 may include historical hardware data exhibited by the computing device, or similar computing devices, during previous executions of application(s) or user behavior corresponding to the predicted application(s) or user behavior 700. As discussed above, the learning and/or first classification model operations may include the operations for implementing various learning and/or first classification models. The learning and/or first classification model 600 may apply the inputs to these models to learn and decide 704 from the inputs what configurations of the cache memory may fall within certain margins of error for the predicted application(s) or user behavior 700. The configurations of the cache memory may be found to fall within certain margins of error for a range of hardware data values. The range of hardware data values may be used as threshold values 706 of hardware data, such that hardware data of a computing device falling within a range of the threshold values 706 may trigger the use of the cache memory configuration correlated with the range of hardware data.

FIG. 8 illustrates an example relational storage of cache memory configuration parameters in accordance with an aspect. With reference to FIGS. 1-7, in this example, the relational storage of cache memory configuration parameters 800 may be represented in a table or database format. However, it is contemplated that the format may be that of any data structure or organizational method that may keep records of the relationship between the cache memory configuration parameters so that they may be retrieved together. Any group of cache memory configuration parameters 818-826 may include a predicted application(s) or user behavior 802, a context 804, threshold hardware data values 806, 810, 814, and cache memory configuration vectors 808, 812, 816. In an aspect, each group of cache memory configuration parameters 818-826 may include one or more threshold hardware data values 806, 810, 814 and cache memory configuration vectors 808, 812, 816, and the number of threshold hardware data values 806, 810, 814 and cache memory configuration vectors 808, 812, 816 may be consistent or inconsistent between cache memory configuration parameters. In an aspect, each of the threshold hardware data values 806, 810, 814 may be correlated with one of the cache memory configuration vectors 808, 812, 816. Each pair of threshold hardware data values 806, 810, 814 and cache memory configuration vectors 808, 812, 816 and each context 804 may be correlated with a predicted application(s) or user behavior 802.

The example in FIG. 8 shows that threshold hardware data values 806, 810, 814 are grouped into columns having like hardware data types (e.g., cache memory related data: set access frequency, dead set count, cache miss count, and cache hit count, etc., and individual or combined processor/processor core related data: number of memory access requests, processing frequency, current leakage, temperature, and power draw, etc.). However, it is not necessary to group like hardware data types together as shown in the example. It is contemplated that columns of threshold hardware data values 806, 810, 814 may include various hardware data types. Further, it is not necessary that each group of cache memory configuration parameters 818-826 have an entry for each pair of columns of threshold hardware data values 806, 810, 814 and cache memory configuration vectors 808, 812, 816.

Continuing with the example in FIG. 8, it is illustrated that a group of cache memory configuration parameters 818 includes a predicted application 802 “Application A,” and a context 804 “After Work Hours.” Thus, the group of cache memory configuration parameters 818 is related to a prediction that after work hours, the application A is likely to be executed on the computing device. The learning components and first classification components have used various data to correlate application A with execution during after work hours, as described herein with reference to FIGS. 6, 7 10, and 11. Further, it is illustrated that the group of cache memory configuration parameters 818 includes three pairs of threshold hardware data values 806, 810, 814 and cache memory configuration vectors 808, 812, 816 (e.g., Set Access Frequency A1 and Vector A1, Cache Miss Count B1 and Vector B1, and Cache Hit Count C1 and Vector C1). The learning components and first classification components have used various data to correlate the threshold hardware data values 806, 810, 814 and cache memory configuration vectors 808, 812, 816 of the group of cache memory configuration parameters 818, as described herein with reference to FIGS. 6, 7 10, and 11. Each correlation of predicted application(s) and user behavior 802, context 804, threshold hardware data values 806, 810, 814 and cache memory configuration vectors 808, 812, 816 may be used to create or update a group of cache memory configuration parameters 818-826.

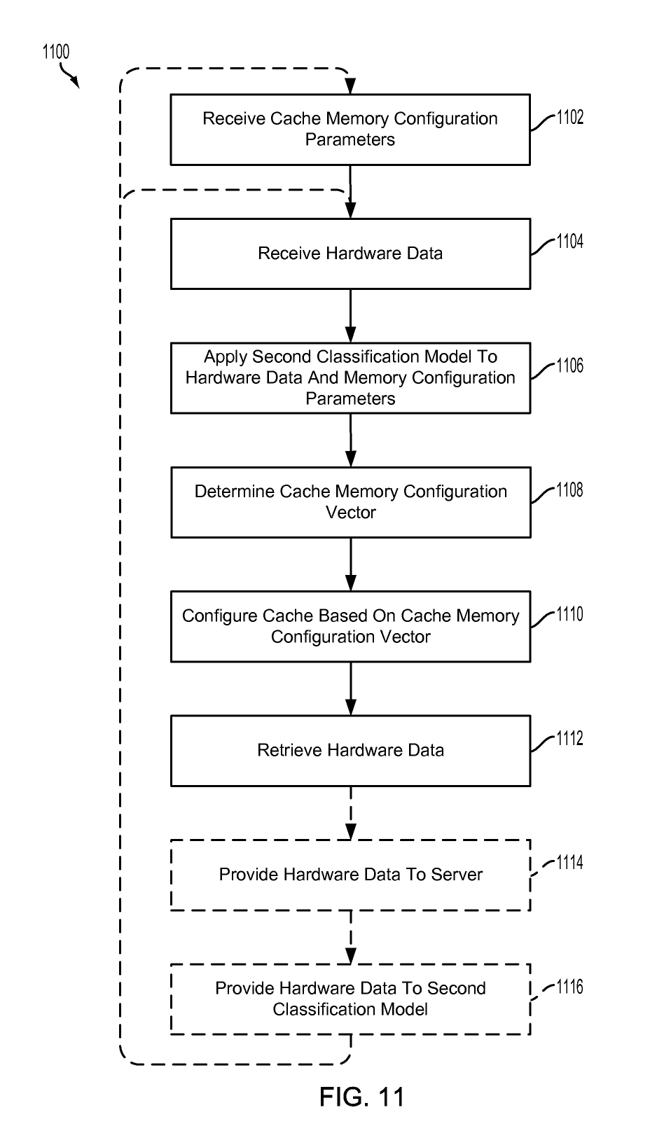

The groups of cache memory configuration parameters 818-826 may be provided to the second classification component individually, in groups, on demand/by request, or by scheduled transmission, using internal communication, external communication, direct communication, or broadcast. It is contemplated that portions of a group of cache memory configuration parameters 818-826 may be provided, rather than an entire group of cache memory configuration parameters 818-826. As discussed further with reference to FIG. 11, the second classification component may use the groups of cache memory configuration parameters 818-826 to select cache memory configuration vectors 808, 812, 816 for implementation by the cache memory configuration component.

FIG. 9 illustrates an example cache memory variably configured in accordance with an aspect. The cache memory 900 may include various numbers of cache ways 902-916 and cache sets 918-932. The cache memory 900 may also include a number cache words, cache lines, cache pages, cache partitions, and cache banks (not shown). The cache memory 900 may also belong to one of a number of cache levels. Each of these cache elements may be cache memory configuration parameters of a cache memory configuration vector, which may also include cache management policy parameters (e.g., associativity, replacement policy, partition overlap allowance, etc.). An example cache memory configuration vector may be visually represented as a series of cache memory configuration parameters, such as <cache partition size, associativity, cache line size, cache replacement policy>. Values for each cache memory configuration parameters may be used to instruct the cache memory configuration component to create, edit, or remove cache partitions based on the cache memory configuration parameters. Continuing the with previous example, the cache memory configuration vector may be visually represented as a series of values of cache memory configuration parameters, such as <16-128K, 2-4 ways 64K, pseudo-least recently used (LRU) or LRU>.

The example cache memory 900 includes five partitions 934-942. Each cache memory partition 934-942 may be dictated with a different cache memory configuration vector and associated for use by a predicted application within a context for the computing device having the cache memory 900. In an example, each cache memory partition 934-942 may correspond with one of the pairs of threshold hardware data values 806, 810, 814 and cache memory configuration vectors 808, 812, 816 of the groups of cache memory configuration parameters 818-826 as described with reference to FIG. 8.

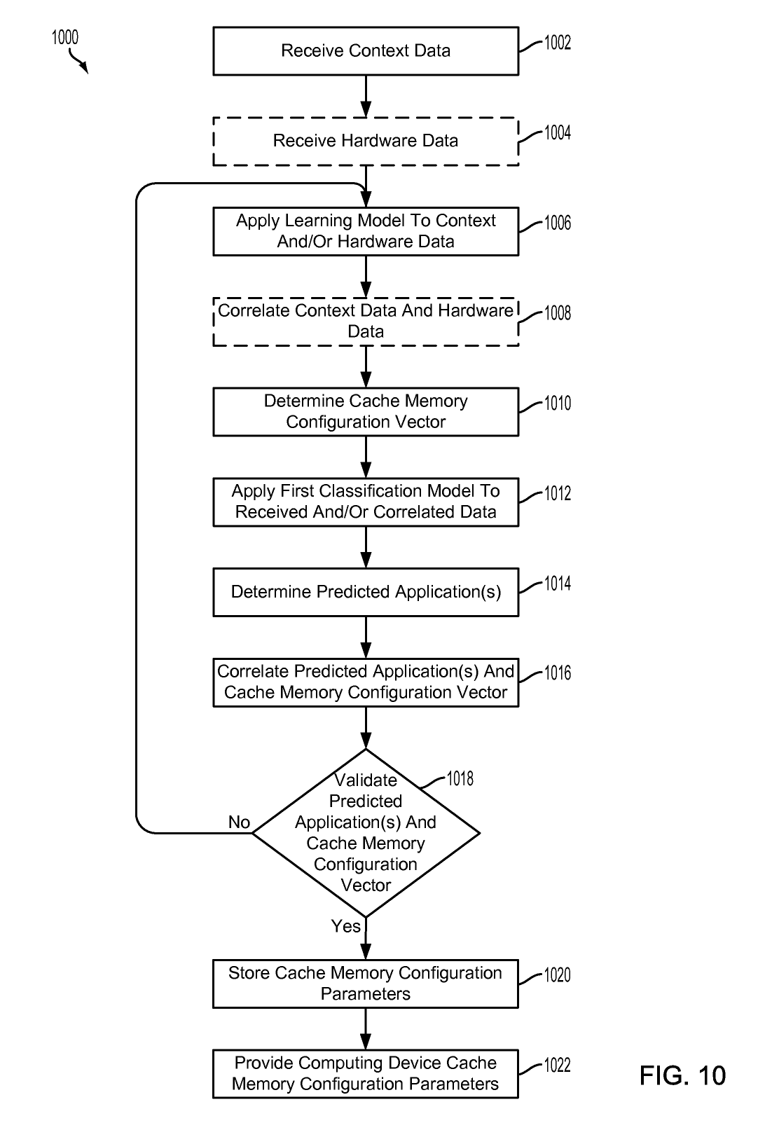

FIG. 10 illustrates an aspect method 1000 for cache memory configuration parameter generation. With reference to FIGS. 1-9, the method 1000 may be executed by one or a combination of computing devices and their components. The descriptions below with reference to FIG. 10 may describe a computing device and a configurable cache memory, which may be the same or separate computing devices. In block 1002, the computing device may receive context data. The context data may include data relating to applications, users, computing devices, and other factors, for example, as described with reference to FIG. 6, for helping predict usage of the configurable cache memory computing device and determine potential configurations for improving the function of the configurable cache memory computing device based on a variety of goals. In optional block 1004, the computing device may receive hardware data from the configurable cache memory and processor(s)/processor core(s), individual or combined, related to the dedicated and shared configurable cache memory. In an aspect, the configurable cache memory may not have a history of relevant hardware data to provide or may not be in communication with the computing device at the time the computing device implements the method 1000.

In block 1006, the computing device may apply a learning model to the context and/or hardware data. The learning model may be any or a combination of known learning models. In optional block 1008, the computing device may correlate the context data and the hardware data. Correlating the context data and the hardware data may only be achievable if the computing device received hardware data in optional block 1004. Correlating the context data and the hardware data allows the computing device to track relevant data for use to predict usage of the configurable cache memory computing device and determine potential configurations for improving the function of the configurable cache memory computing device. Correlations may be made on a variety of bases, such as correlating context data that matches to the hardware data for the execution of a particular application or particular user behavior on the configurable cache memory computing device. In block 1010, the computing device, executing the learning model, may determine one or more cache memory configuration vectors associated with one or more correlated hardware and context data. The hardware data associated with the cache memory configuration vectors may include acceptable ranges/thresholds of hardware data for the cache memory configuration vectors. Examples of the correlated hardware and context data being associated with the one or more cache memory configuration vectors are described with reference to FIG. 8.

In block 1012, the computing device may apply the first classification model to the received and/or correlated hardware and context data. The first classification model may be any or a combination of known learning models. In block 1014, the computing device may determine a predicted application(s) or user behavior. As described with reference to FIG. 6, the computing device, using classifiers of the first classification model, may analyze a number of feature vectors, including received and/or correlated hardware and context data, to determine a likelihood of execution of an application(s) or a user behavior. In block 1016, the computing device may correlate the predicted application(s) or user behavior with the cache memory configuration vector for implementing the predicted application(s) or user behavior with reference to the context data and hardware data.

The correlation of the different data, predictions, and configuration vectors may help avoid potential misalignment of data, predictions, and configurations with similar other data, predictions, or configurations. For example, the execution of the same predicted application may benefit from different cache memory configurations for different context data and/or hardware data. The following example illustrates this point. A context or non-work hours may be indicative of pre-work hours, post-work hours, or weekend hours. A predicted application may be predicted to be executed during one or more of the non-work hour contexts. However, the computing device may be used differently during the pre-work hours, post-work hours, and weekend hours. Thus, a cache memory configuration for the same application may vary for the different contexts. Therefore, correlating the data, predictions, and configuration vectors may help the correct cache memory configuration to be implemented for the application during the correct context.

In determination block 1018, the computing device may validate the predicted application(s) or user behavior and associated cache memory configuration vectors. Validating may include determining whether the predictions and configurations are likely to improve the function of the configurable cache memory computing device. The computing device may use algorithms or simulations to determine whether the performance of the configurable cache memory computing device is likely to improve based on whether the results of the validation fall within an acceptable range of validation values. In response to determining that the predicted application(s) or user behavior and associated cache memory configuration vectors are invalid (i.e. determination block 1018=“No”), the computing device may return to apply the learning model to the context and/or hardware data in block 1006. The computing device may return error values from the validation procedure which the computing device may use to alter the application of the learning model or select a different learning model to improve the results.

In response to determining that the predicted application(s) or user behavior and associated cache memory configuration vectors are valid (i.e. determination block 1018=“Yes”), the computing device may store the cache memory configuration parameters, in block 1020. As described with reference to FIG. 8, the cache memory configuration parameters may include the predicted applications(s) or user behavior and the relevant context data, the hardware data ranges/thresholds, and the cache memory configuration vectors, as described with reference. In block 1022, the computing device may provide the cache memory configuration parameters to the configurable cache memory computing device. The cache memory configuration parameters may be provided to the configurable cache memory computing device individually, in groups, on demand/by request, or by scheduled transmission, using internal communication, external communication, direct communication, or broadcast.

In an aspect, the method 1000 may be executed by the computing device offline. Offline execution may be execution on a computing device different from the configurable cache memory computing device, or on the configurable cache memory computing device, but not during runtime of the predicted application(s) or user behavior.

FIG. 11 illustrates an aspect method 110 for self-adaptive cache memory configuration. With reference to FIGS. 1-10, the method 1100 may be executed by one or a combination of computing devices and their components. The descriptions below with reference to FIG. 11 may describe a computing device and a configurable cache memory, which may be the same or separate computing devices. In block 1102, the cache configurable computing device may receive cache memory configuration parameters. The cache memory configuration parameters may be received individually, in groups, on demand/by request, or by scheduled transmission, using internal communication, external communication, direct communication, or broadcast. In an aspect, the cache configurable computing device may store the received cache memory configuration parameters on a volatile or non-volatile memory for use when the cache configurable computing device should be configured according to the cache memory configuration parameters. The cache configurable computing device may be configured according to the cache memory configuration parameters, for example, when at least one of the predicated application(s) or user behavior and context data matches conditions on the cache configurable computing device.

In block 1104, the cache configurable computing device may receive or retrieve its own hardware data. The cache configurable computing device may access the stored hardware data, such as hardware counters or hardware data stored in volatile or non-volatile memory devices. In block 1106, the cache configurable computing device may apply a second classification model to the cache memory configuration parameters and/or hardware data. The second classification model may be any or a combination of known classification models. In block 1108, the cache configurable computing device may select a cache memory configuration vector for use in configuring the cache memory of the cache configurable computing device. In an aspect, the second classification model may use the threshold hardware data values of the cache memory configuration parameters to select which of the cache memory configuration vectors to use. A visual representation of the process of selecting the appropriate cache memory configuration vector may be illustrated by the following example of a set of rules that the machine learning algorithm learns:

if 40%<D<=50% then set cache to <128K, 1-way>;
if 30%<D<=40% then set cache to <128K, 1-way>;
if D>50% then set cache to <256, 2-way>.

In the above example, the hardware threshold values are related to the corollary, D=1−S, of set access frequency, S, of the cache memory. In an aspect, the parameter for determining the hardware threshold values may be set access frequency, S, itself. The set access frequency may count the percentage of accesses to a cache set within a time interval. Depending on the percentage of accesses to a cache set within a time interval, the cache configurable computing device may select a different designated cache memory configuration vector having a cache memory partition size value and a cache memory associativity. This example is not meant to be limiting, and the hardware data, hardware data thresholds, cache memory configuration vectors, and parameters means and methods for comparing the hardware data and hardware data thresholds may vary.

In block 1110, the cache configurable computing device may configure the cache memory based on the selected cache memory configuration vector. For example, the cache memory configuration component may receive the cache memory configuration vector from the second classification component and control access and management of the cache memory according to the parameter values of the selected cache memory configuration vector. In an aspect, the cache memory configuration component my not itself control access to and management of the cache memory, but may instruct cache memory controllers to control access to and management of the cache memory. In block 1112, the cache configurable computing device may retrieve hardware data relating to the new configuration of the cache memory. In block 1114, the cache configurable computing device may provide the hardware data to the computing device for implementing the method 1000 as described with reference to FIG. 10. The cache configurable computing device may provide the retrieved hardware data to the computing device individually, in groups, on demand/by request, or by scheduled transmission, using internal communication, external communication, direct communication, or broadcast. In optional block 1116, the cache configurable computing device may provide the hardware data to the second classification model, and the cache configurable computing device may receive cache memory configuration parameters in block 1102 and/or the hardware data may be received in block 1104. In an aspect, providing the hardware data related to the new cache memory configuration to the second classification model may prompt the cache configurable computing device to proceed to apply the second classification model to the cache memory configuration parameters and/or hardware data, in block 1106. Repeating the process of method 1100 starting at block 1106 may allow the cache configurable computing device to update the cache memory configuration as the execution of the predicted application(s) or user behavior continues, changes, or if the predicted application(s) or user behavior is wrong.

In an aspect, various blocks 1102-1116 of the method 1100 may be executed by the configurable cache memory computing device during runtime of the configurable cache memory computing device. In an aspect, various blocks 1102-1116 of the method 1100 may be executed by the configurable cache memory computing device offline. In an aspect, offline execution may be execution on the configurable cache memory computing device or a computing device different from the configurable cache memory computing device, but not during runtime of the predicted application(s) or user behavior.

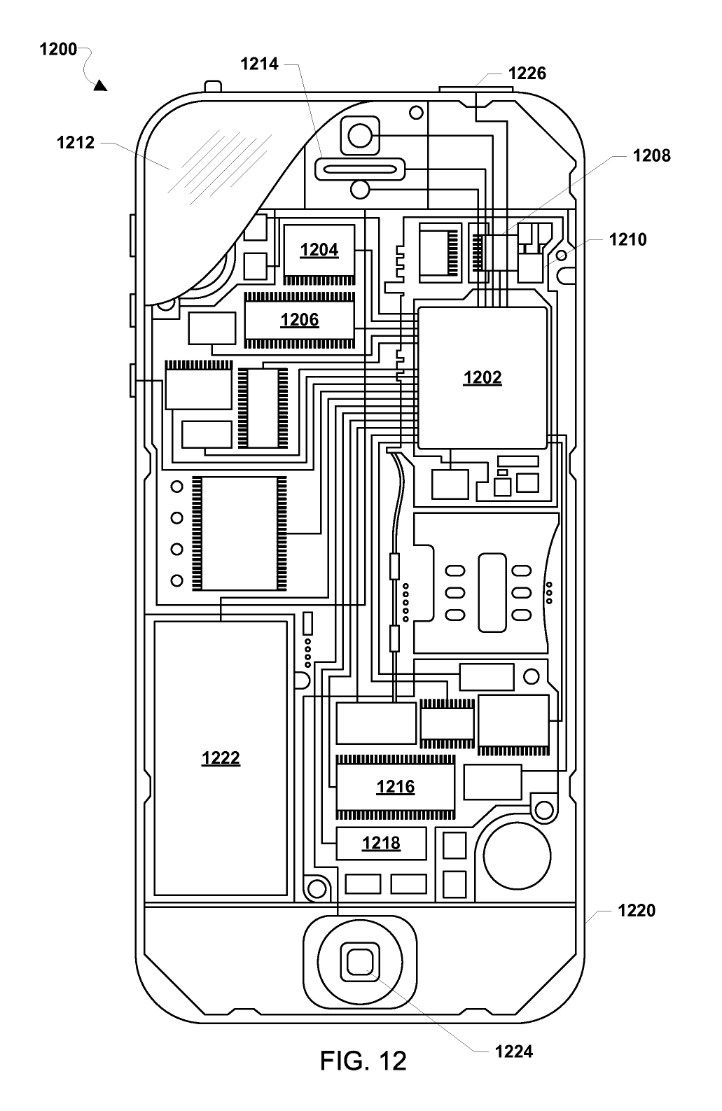

FIG. 12 illustrates an example mobile device suitable for use with the various aspects. With reference to FIGS. 1-11, the mobile device 1200 may include the computing devices and components described with reference to FIGS. 1-7, 13, and 14. The mobile device 1200 may include a processor 1202 coupled to a touchscreen controller 1204 and an internal memory 1206. The processor 1202 may be one or more multicore integrated circuits designated for general or specific processing tasks. The internal memory 1206 may be volatile or non-volatile memory, and may also be secure and/or encrypted memory, or unsecure and/or unencrypted memory, or any combination thereof. Examples of memory types which can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1204 and the processor 1202 may also be coupled to a touchscreen panel 1212, such as a resistive-sensing touchscreen, capacitive-sensing touchscreen, infrared sensing touchscreen, etc. Additionally, the display of the computing device 1200 need not have touch screen capability.

The mobile device 1200 may have one or more radio signal transceivers 1208 (e.g., Peanut, Bluetooth, Zigbee, Wi-Fi, RF radio) and antennae 1210, for sending and receiving communications, coupled to each other and/or to the processor 1202. The transceivers 1208 and antennae 1210 may be used with the above-mentioned circuitry to implement the various wireless transmission protocol stacks and interfaces. The mobile device 1200 may include a cellular network wireless modem chip 1216 that enables communication via a cellular network and is coupled to the processor.

The mobile device 1200 may include a peripheral device connection interface 1218 coupled to the processor 1202. The peripheral device connection interface 1218 may be singularly configured to accept one type of connection, or may be configured to accept various types of physical and communication connections, common or proprietary, such as USB, FireWire, Thunderbolt, or PCIe. The peripheral device connection interface 1218 may also be coupled to a similarly configured peripheral device connection port (not shown).

The mobile device 1200 may also include speakers 1214 for providing audio outputs. The mobile device 1200 may also include a housing 1220, constructed of a plastic, metal, or a combination of materials, for containing all or some of the components discussed herein. The mobile device 1200 may include a power source 1222 coupled to the processor 1202, such as a disposable or rechargeable battery. The rechargeable battery may also be coupled to the peripheral device connection port to receive a charging current from a source external to the mobile device 1200. The mobile device 1200 may also include a physical button 1224 for receiving user inputs. The mobile device 1200 may also include a power button 1226 for turning the mobile device 1200 on and off.

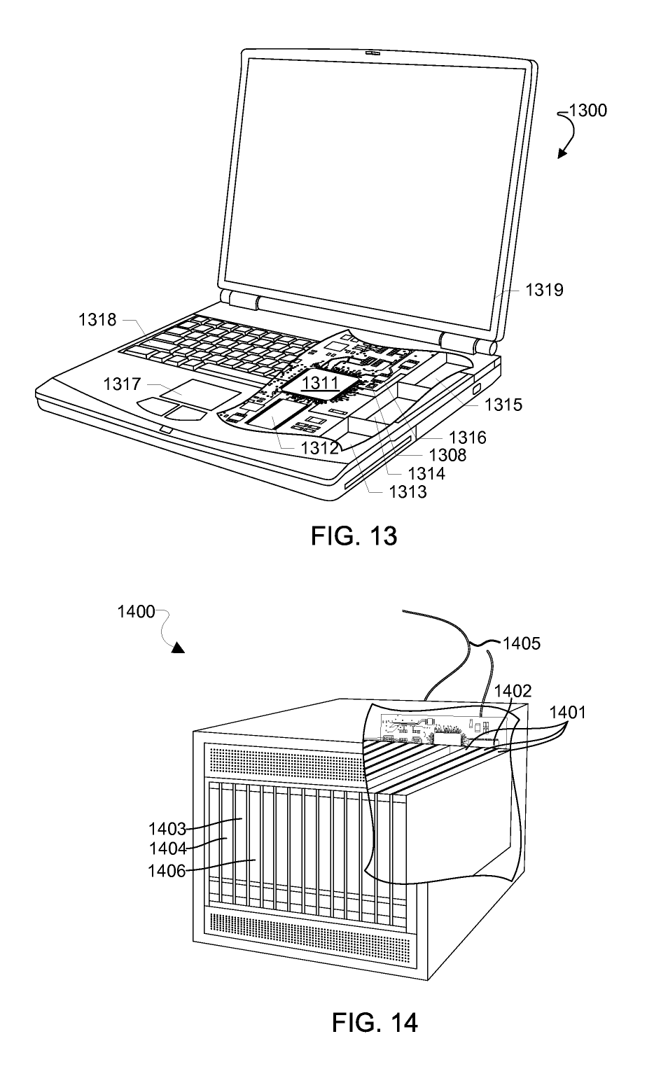

The various aspects described above may also be implemented within a variety of mobile devices, such as a laptop computer 1300 illustrated in FIG. 13. With reference to FIGS. 1-12, the laptop computer 1300 may include the computing devices and components described with reference to FIGS. 1-7, 12, and 14. Many laptop computers include a touchpad touch surface 1317 that serves as the computer's pointing device, and thus may receive drag, scroll, and flick gestures similar to those implemented on computing devices equipped with a touch screen display and described above. A laptop computer 1300 will typically include a processor 1311 coupled to volatile memory 1312 and a large capacity nonvolatile memory, such as a disk drive 1313 of Flash memory. Additionally, the computer 1300 may have one or more antenna 1308 for sending and receiving electromagnetic radiation that may be connected to a wireless data link and/or cellular telephone transceiver 1316 coupled to the processor 1311. The computer 1300 may also include a floppy disc drive 1314 and a compact disc (CD) drive 1315 coupled to the processor 1311. In a notebook configuration, the computer housing includes the touchpad 1317, the keyboard 1318, and the display 1319 all coupled to the processor 1311. Other configurations of the computing device may include a computer mouse or trackball coupled to the processor (e.g., via a USB input) as are well known, which may also be use in conjunction with the various aspects.

The various aspects (including, but not limited to, aspects discussed above with reference to FIGS. 1-13) may be implemented in a wide variety of computing systems, which may include any of a variety of commercially available servers. An example server 1400 is illustrated in FIG. 14. Such a server 1400 typically includes one or more multi-core processor assemblies 1401 coupled to volatile memory 1402 and a large capacity nonvolatile memory, such as a disk drive 1404. As illustrated in FIG. 14, multi-core processor assemblies 1401 may be added to the server 1400 by inserting them into the racks of the assembly. The server 1400 may also include a floppy disc drive, compact disc (CD) or DVD disc drive 1406 coupled to the processor 1401. The server 1400 may also include network access ports 1403 coupled to the multi-core processor assemblies 1401 for establishing network interface connections with a network 1405, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many computing devices operating system kernels are organized into a user space (where non-privileged code runs) and a kernel space (where privileged code runs). This separation is of particular importance in Android and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present invention is not intended to be limited to the aspects shown herein but is to be accorded the widest scope consistent with the following claims and the principles and novel features disclosed herein.

What is claimed is:

1. A method for generating a cache memory configuration, comprising:
applying machine learning to context data;
determining a first cache memory configuration relating to the context data for a cache memory of a computing device; and
predicting execution of an application on the computing device.

2. The method of claim 1, wherein:
applying machine learning to context data further comprises applying machine learning to the context data and hardware data of the computing device related to the context data; and
determining a first cache memory configuration relating to the context data for a cache memory of a computing device comprises determining the first cache memory configuration relating to the context data and hardware data thresholds for the cache memory of the computing device.

3. The method of claim 1, further comprising correlating the predicted application and the first cache memory configuration.

4. The method of claim 1, further comprising:
validating the predicted application and the first cache memory configuration;
storing the predicted application and the first cache memory configuration in response to the predicted application and the first cache memory configuration being valid; and
altering the machine learning with an error value in response to the predicted application and the first cache memory configuration being invalid.

5. The method of claim 1, further comprising:
classifying a plurality of cache memory configurations based on at least a hardware data threshold of the computing device and first hardware data of the computing device, wherein the plurality of cache memory configurations are related to a predicted application execution;
selecting the first cache memory configuration from the plurality of cache memory configurations in response to the classification of the plurality of cache memory configurations indicating the first cache memory configuration as classified for the first hardware data of the computing device; and
configuring the cache memory at runtime based on the first cache memory configuration.

6. The method of claim 5, further comprising:
receiving a plurality of cache memory parameters, wherein each of the plurality of cache memory parameters are associated with context data, at least one hardware data threshold of the computing device, the predicted application execution, and at least one cache memory configuration.

7. The method of claim 5, further comprising:
receiving second hardware data of the computing device after configuring the cache memory at runtime based on the selected first cache memory configuration;
classifying the plurality of cache memory configurations based on at least one hardware data threshold of the computing device and the second hardware data of the computing device;
selecting a second cache memory configuration from the plurality of cache memory configurations in response to the classification of the plurality of cache memory configurations indicating the second cache memory configuration as classified for the second hardware data of the computing device; and
configuring the cache memory at runtime based on the second cache memory configuration.

8. The method of claim 7, wherein the first hardware data and the second hardware data each comprise at least one of cache memory related data, data related to a first processor wherein the first processor is associated with a dedicated cache memory, data related to a second processor, and data related to a third processor wherein the second processor and the third processor are associated with a shared cache memory.

9. A method for configuring a cache memory of a computing device, comprising:
classifying a plurality of cache memory configurations based on at least a hardware data threshold of the computing device and first hardware data of the computing device, wherein the plurality of cache memory configurations are related to a predicted application execution;
selecting a first cache memory configuration from the plurality of cache memory configurations in response to the classification of the plurality of cache memory configurations indicating the first cache memory configuration as classified for the first hardware data of the computing device; and
configuring the cache memory at runtime based on the first cache memory configuration.

10. The method of claim 9, further comprising:
receiving a plurality of cache memory parameters, wherein each of the plurality of cache memory parameters are associated with context data, at least one hardware data threshold of the computing device, the predicted application execution, and at least one cache memory configuration.

11. The method of claim 9, further comprising:
receiving second hardware data of the computing device after configuring the cache memory at runtime based on the selected first cache memory configuration;
classifying the plurality of cache memory configurations based on at least one hardware data threshold of the computing device and the second hardware data of the computing device;
selecting a second cache memory configuration from the plurality of cache memory configurations in response to the classification of the plurality of cache memory configurations indicating the second cache memory configuration as classified for the second hardware data of the computing device; and
configuring the cache memory at runtime based on the second cache memory configuration.

12. The method of claim 11, wherein the first hardware data and the second hardware data each comprise at least one of cache memory related data, data related to a first processor wherein the first processor is associated with a dedicated cache memory, data related to a second processor, and data related to a third processor, wherein the second processor and the third processor are associated with a shared cache memory.

13. The method of claim 9, further comprising:
applying machine learning to context data;
determining the first cache memory configuration relating to the context data for the cache memory of the computing device; and
predicting execution of an application on the computing device.

14. The method of claim 13, wherein:
applying machine learning to context data further comprises applying machine learning to the context data and hardware data of the computing device related to the context data; and
determining the first cache memory configuration relating to the context data for the cache memory of the computing device comprises determining the first cache memory configuration relating to the context data and the hardware data threshold for the cache memory of the computing device.

15. The method of claim 13, further comprising correlating the predicted application and the first cache memory configuration.

16. The method of claim 13, further comprising:
validating the predicted application and the first cache memory configuration;
storing the predicted application and the first cache memory configuration in response to the predicted application and the first cache memory configuration being valid; and
altering the machine learning with an error value in response to the predicted application and the first cache memory configuration being invalid.

17. A computing device, comprising:
a cache memory; and
a processor coupled to the cache memory and configured with processor-executable instructions to perform operations comprising:
applying machine learning to context data;
determining a first cache memory configuration relating to the context data for the cache memory of the computing device; and
predicting execution of an application on the computing device.

18. The computing device of claim 17, wherein the processor is configured with processor-executable instructions to perform operations such that:
applying machine learning to context data further comprises applying machine learning to the context data and hardware data of the computing device related to the context data; and
determining a first cache memory configuration relating to the context data for a cache memory of a computing device comprises determining the first cache memory configuration relating to the context data and hardware data thresholds for the cache memory of the computing device.

19. The computing device of claim 17, wherein the processor is configured with processor-executable instructions to perform operations further comprising correlating the predicted application and the first cache memory configuration.

20. The computing device of claim 17, wherein the processor is configured with processor-executable instructions to perform operations further comprising:
validating the predicted application and the first cache memory configuration;
storing the predicted application and the first cache memory configuration in response to the predicted application and the first cache memory configuration being valid; and
altering the machine learning with an error value in response to the predicted application and the first cache memory configuration being invalid.

21. The computing device of claim 17, wherein the processor is configured with processor-executable instructions to perform operations further comprising:
classifying a plurality of cache memory configurations based on at least a hardware data threshold of the computing device and first hardware data of the computing device, wherein the plurality of cache memory configurations are related to a predicted application execution;
selecting the first cache memory configuration from the plurality of cache memory configurations in response to the classification of the plurality of cache memory configurations indicating the first cache memory configuration as classified for the first hardware data of the computing device; and
configuring the cache memory at runtime based on the first cache memory configuration.

22. The computing device of claim 21, wherein the processor is configured with processor-executable instructions to perform operations further comprising:
receiving a plurality of cache memory parameters, wherein each of the plurality of cache memory parameters are associated with context data, at least one hardware data threshold of the computing device, the predicted application execution, and at least one cache memory configuration.

23. The computing device of claim 21, wherein the processor is configured with processor-executable instructions to perform operations further comprising:
receiving second hardware data of the computing device after configuring the cache memory at runtime based on the selected first cache memory configuration;
classifying the plurality of cache memory configurations based on at least one hardware data threshold of the computing device and the second hardware data of the computing device;
selecting a second cache memory configuration from the plurality of cache memory configurations in response to the classification of the plurality of cache memory configurations indicating the second cache memory configuration as classified for the second hardware data of the computing device; and
configuring the cache memory at runtime based on the second cache memory configuration.

24. A computing device, comprising:
a cache memory; and
a processor coupled to the cache memory and configured with processor-executable instructions to perform operations comprising:
classifying a plurality of cache memory configurations based on at least a hardware data threshold of the computing device and first hardware data of the computing device, wherein the plurality of cache memory configurations are related to a predicted application execution;
selecting a first cache memory configuration from the plurality of cache memory configurations in response to the classification of the plurality of cache memory configurations indicating the first cache memory configuration as classified for the first hardware data of the computing device; and
configuring the cache memory at runtime based on the first cache memory configuration.

25. The computing device of claim 24, wherein the processor is configured with processor-executable instructions to perform operations further comprising:
receiving a plurality of cache memory parameters, wherein each of the plurality of cache memory parameters are associated with context data, at least one hardware data threshold of the computing device, the predicted application execution, and at least one cache memory configuration.

26. The computing device of claim 24, wherein the processor is configured with processor-executable instructions to perform operations further comprising:
receiving second hardware data of the computing device after configuring the cache memory at runtime based on the selected first cache memory configuration;
classifying the plurality of cache memory configurations based on at least one hardware data threshold of the computing device and the second hardware data of the computing device;
selecting a second cache memory configuration from the plurality of cache memory configurations in response to the classification of the plurality of cache memory configurations indicating the second cache memory configuration as classified for the second hardware data of the computing device; and
configuring the cache memory at runtime based on the second cache memory configuration.

27. The computing device of claim 24, wherein the processor is configured with processor-executable instructions to perform operations further comprising:
applying machine learning to context data;
determining the first cache memory configuration relating to the context data for the cache memory of the computing device; and
predicting execution of an application on the computing device.

28. The computing device of claim 27, wherein the processor is configured with processor-executable instructions to perform operations such that:
applying machine learning to context data further comprises applying machine learning to the context data and hardware data of the computing device related to the context data; and
determining the first cache memory configuration relating to the context data for the cache memory of the computing device comprises determining the first cache memory configuration relating to the context data and the hardware data threshold for the cache memory of the computing device.

29. The computing device of claim 27, wherein the processor is configured with processor-executable instructions to perform operations further comprising correlating the predicted application and the first cache memory configuration.

30. The computing device of claim 27, wherein the processor is configured with processor-executable instructions to perform operations further comprising:
validating the predicted application and the first cache memory configuration;
storing the predicted application and the first cache memory configuration in response to the predicted application and the first cache memory configuration being valid; and
altering the machine learning with an error value in response to the predicted application and the first cache memory configuration being invalid.
